(19) United States
(12) Patent Application Publication
(10) Pub. No.: US 2004/0068043 A1
(43) Pub. Date: Apr. 8, 2004

(54) Aqueous resin dispersion and method for producing the same

(76) Inventor: Fumitoshi Tsukiyama, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/466,686

(22) PCT Filed: Sep. 27, 2002
(86) PCT No.: PCT/JP02/10135

(30) Foreign Application Priority Data
Jan. 25, 2002 (JP) 2002-17376
Jan. 25, 2002 (JP) 2002-17377
Jun. 26, 2002 (JP) 2002-186761
Jun. 26, 2002 (JP) 2002-186762

(51) Int. Cl. C08L 33/00

(52) U.S. Cl. 524/523; 524/502

(57) ABSTRACT

The present invention provides an aqueous resin dispersion having a relatively low acid value and high viscosity and structural viscosity after alkali neutralization, and a method for producing the same. An aqueous resin dispersion obtained by preparing an aqueous solution resin (A) for emulsion polymerization having an acid value of 30 to 150 and a hydroxyl group value of 10 to 100 by solution-polymerizing an acid group-containing polymerizable unsaturated monomer (a), a hydroxyl group-containing polymerizable unsaturated monomer (b), and any other polymerizable unsaturated monomer (c) in organic solvent to produce an organic solvent solution of a copolymer, converting the organic solvent solution into an aqueous solution, and removing the organic solvent under-reduced pressure; and synthesizing a resin (B) having an acid value of not more than 20 and a hydroxyl group value of not more than 100 in a protective colloid by using the aqueous solution resin (A) for emulsion polymerization prepared in step (1) as said protective colloid and by emilsion-polymerizing the monomer (c), and optionally the monomer (b), and optionally the monomer (a). The resin (A) for emulsion polymerization may be obtained by aqueous-solution-polymerizing the monomer (a), the monomer (b) and the monomer (c) in water.

### TECHNICAL FIELD

The present invention relates to an aqueous resin dispersion having an excellent thickening performance and a structural viscosity and comprising a synthetic resin emulsion which exerts an excellent curing performance when a melamine resin is used as a curing agent, and a method for producing the same.

### BACKGROUND ART

In various usages of a synthetic resin emulsion, there are cases, for example, where the electrostatic fiber implanting process of a short fiber pile is applied to various substrates such as an ABS resin, polystyrene, polyvinyl chloride, polypropylene and fabric, and where the synthetic resin emulsion is used for various automobile coating materials such as base coating materials and for constructions or building materials. Such usage of the synthetic resin emulsion requires excellent coating workability and coating suitability upon coating by use of various coating tools such as roll, coating bar, spray, air spray electrostatic coater (bell-shape type and the like), and also requires exerting of high alkali thickening performance and structural viscosity upon neutralizing acid components in the resin with basic compounds such as ammonia and various amines for the purpose of ensuring a sagging resistance of thick coating film immediately after coating. In addition, melamine cross-linking performance is also required. However, it has been difficult for conventional aqueous resin dispersions to obtain a high viscosity and structural viscosity at a relatively low acid value.

More specifically, in the use for electrostatic fiber implanting process, for example, nylon or polypropylene pile is electrostatically implanted under a high voltage after applying resin on substrate. In this process, the conventional aqueous resin dispersions allow an implanted pile to randomly slip or move due to an insufficient viscosity or structural viscosity of the applied resin, resulting in considerably poor appearance of processed article after drying.

Also in the use for waterborne automobile base coat, particularly in the case of metallic coating, an aqueous base coating composition mixed with an aluminum paste produced generally from an aluminum flake pigment, a carboxyl group-containing and hydroxyl group-containing acrylic resin dispersions thickened by neutralizing with a basic compound (alkali) such as dimethylethanolamine, and a melamine resin is electrostatically coated on the surface of the coating film which is formed by cation electric deposition on a steel plate followed by coating inner coating material on a steel plate and then heat curing. In such case, conventional acrylic resin dispersions allow the coating material to sag along the vertical surface due to an insufficient viscosity or structural viscosity after coating resulting from an insufficient alkali thickening performance, or allow the aluminum orientation to be deviated due to the strenuous movement of the coating material after coating, resulting in considerably poor appearance of the dried and cured coating film. In addition, the conventional acrylic resin dispersions with a sufficient viscosity and structural viscosity contain the excessive amount of carboxylic acid, which results in considerably poor water resistance of the coating film obtained.

Under such a circumstance, development of an aqueous resin dispersion having a relatively low acid value, which allows the resultant coating film to have an excellent water resistance, and also having a high viscosity and structural viscosity after being neutralized with alkali has been awaited.

### DISCLOSURE OF THE INVENTION

### OBJECT OF THE INVENTION

Accordingly, an object of the present invention is to solve the problems associated with the above described conventional art, and to provide an aqueous resin dispersion having a relatively low acid value and also having a high viscosity and structural viscosity after being neutralized with alkali, and a method for producing the same.

### SUMMARY OF THE INVENTION

The present inventor has made an effort and then found that the above described object can be achieved by an aqueous resin dispersion produced as follows: a plurality of monomer components, mainly including an acrylic monomer, are polymerized in such a ratio as to obtain a resin having a relatively low acid value in the presence of an organic solvent to obtain an organic solvent solution of a copolymer, the acid groups in the copolymer is neutralized with alkali, water is added to make an aqueous solution, and after that the organic solvent is removed under reduced pressure, to obtain the aqueous solution of the resin, and then, by using the aqueous solution of the resin as a protective colloid, an acid group-containing monomer which is used in no amount or in a very small amount, a hydroxyl group-containing monomer, and any other monomers such as (meth)acrylate and/or styrenic monomers are emulsion-polymerized to obtain the aqueous resin dispersion. Thus the present invention is completed.

That is, the present invention is an aqueous resin dispersion obtained by:

(1) preparing an aqueous solution resin (A) for emulsion polymerization having an acid value of 30 to 150 and a hydroxyl group value of 10 to 100 by solution-polymerizing an acid group-containing polymerizable unsaturated monomer (a), a hydroxyl group-containing polymerizable unsaturated monomer (b), and any other polymerizable unsaturated monomer (c) in organic solvent to produce an organic solvent solution of a copolymer, converting the organic solvent solution into an aqueous solution, and removing the organic solvent under reduced pressure; and

(2) synthesizing a resin (B) having an acid value of not more than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a),

wherein the aqueous resin dispersion has an initial viscosity of not less than 3,000 mPa.S after thickening with alkali, and a structural viscosity index of not less than 250 after thickening with alkali, which is represented as a ratio between a low shear region (0.1 sec⁻¹) viscosity and a high shear region (100 sec⁻¹) viscosity:

(structural viscosity index)=(low shear region viscosity)/(high shear region viscosity).

In the present invention, thickening with alkali means thickening upon addition of an alkali to the aqueous resin dispersion with a nonvolatile content adjusted to 20% by weight.

The present invention is the aqueous resin dispersion, wherein the any other polymerizable unsaturated monomer (c) includes at least one monomer selected from the group consisting of (meth)acrylates, styrenic monomers, (meth)acrylonitrile, and (meth)acrylamide.

The present invention is the aqueous resin dispersion, wherein the total weight Aw of the polymerizable unsaturated monomers used in the preparation of the resin (A) and the total weight Bw of the polymerizable unsaturated monomers used in the synthesis of the resin (B) satisfy the relationship represented by the following equation:

10/100≦Aw/(Aw+Bw)≦50/100.

The present invention is the aqueous resin dispersion wherein a cross-linkable monomer is used as an additional copolymerization component in the preparation of the resin (A).

The present invention is the aqueous resin dispersion wherein a cross-linkable monomer is used as an additional copolymerization component in the synthesis of the resin (B).

The present invention is the aqueous resin dispersion having a low shear region (0.1 sec⁻¹) viscosity of not less than 5,000 Pa.S and having a high shear region (100 sec⁻¹) viscosity of not more than 20 Pa.S after thickening with alkali.

The present invention is the aqueous resin dispersion wherein the change rate of the viscosity after being allowed to stand for 1 week is within 10% from the initial viscosity after thickening with alkali.

In addition, the present invention is a method for producing an aqueous resin dispersion comprising the steps of:

(1) preparing an aqueous solution resin (A) for emulsion polymerization having an acid value of 30 to 150 and a hydroxyl group value of 10 to 100 by solution-polymerizing an acid group-containing polymerizable unsaturated monomer (a), a hydroxyl group-containing polymerizable unsaturated monomer (b), and any other polymerizable unsaturated monomer (c) in organic solvent to obtain an organic solvent solution of a copolymer, converting the organic solvent solution into an aqueous solution, and removing the organic solvent under reduced pressure; and

(2) synthesizing a resin (B) having an acid value of not mote than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a), thereby obtaining the aqueous resin dispersion.

By this production method, an aqueous resin dispersion with an initial viscosity of not less than 3,000 mPa.S after thickening with alkali and a structural viscosity index of not less than 250, which is represented as a ratio between a low shear region (0.1 sec⁻¹) viscosity and a high shear region (100 sec⁻¹) viscosity:

(structural viscosity index)=(low shear region viscosity)/(high shear region viscosity)

is obtained.

The present invention is the method for producing an aqueous resin dispersion, wherein the any other polymerizable unsaturated monomer (c) includes at least one monomer selected from the group consisting of (meth)acrylates, styrenic monomers, (meth)acrylonitrile, and (meth)acrylamide.

The present invention is the method for producing an aqueous resin dispersion, wherein each of the monomer components are used so that the total weight Aw of the polymerizable unsaturated monomers in the preparation of the resin (A) and the total weight Bw of the polymerizable unsaturated monomers in the synthesis of the resin (B) satisfy the relationship represented by the following equation:

10/100≦Aw/(Aw+Bw)≦50/100.

The present invention is the method for producing an aqueous resin dispersion,.wherein a cross-linkable monomer is used as an additional copolymerization component in the preparation of the resin (A).

The present invention is the method for producing an aqueous resin dispersion, wherein a cross-linkable monomer is used as an additional copolymerization component in synthesizing the resin (B).

Furthermore, the present inventor has made an effort and then found that the above described object can be achieved by the aqueous resin dispersion obtained as follows: a plurality of monomer components, mainly including an acrylic monomer, are aqueous-solution-polymerized in such a ratio as to obtain a resin with a relatively low acid value in water using a radical polymerization initiator to obtain an aqueous-solution of the resin, and then, by using the aqueous solution of the resin as a protective colloid for emulsion polymerization, an acid group-containing monomer which is used in no amount or in a very small amount, a hydroxyl group-containing monomer, and any other monomers such as (meth)acrylate and/or styrenic monomers are emulsion-polymerized to obtain the aqueous resin dispersion. Thus the present invention is completed.

That is, the present invention is an aqueous resin dispersion obtained by:

(1) preparing an aqueous solution resin (A) for emulsion polymerization having an acid value of 30 to 150 and a hydroxyl group value of 10 to 100 by aqueous-solution-polymerizing an acid group-containing polymerizable unsaturated monomer (a), a hydroxyl group-containing polymerizable unsaturated monomer (b), and any other polymerizable unsaturated monomer (c) in water; and

(2) synthesizing a resin (B) having an acid value of not more than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a), wherein the aqueous resin dispersion has an initial viscosity of not less than 3,000 mPa.S after thickening with alkali, and a structural viscosity index of not less than 250 after thickening with alkali, which is represented as a ratio between a low shear region (0.1 sec⁻¹) viscosity and a high shear region (100 sec⁻¹) viscosity:

(structural viscosity index)=(low shear region viscosity)/(high shear region viscosity).

In the present invention, thickening with alkali means thickening upon addition of an alkali to the aqueous resin dispersion with a nonvolatile content adjusted to 20% by weight.

The present invention is the aqueous resin dispersion, wherein the any other polymerizable unsaturated monomer (c) includes at least one monomer selected from the group consisting of (meth)acrylates, styrenic monomers, (meth)acrylonitrile, and (meth)acrylamide.

The present invention is the aqueous resin dispersion, wherein the total weight Aw of the polymerizable unsaturated monomers used in the preparation of the resin (A) and the total weight Bw of the polymerizable unsaturated monomers used in the synthesis of the resin (B) satisfy the relationship represented by the following equation:

10/100≦Aw/(Aw+Bw)≦50/100.

The present invention is the aqueous resin dispersion wherein a cross-linkable monomer is used as an additional copolymerization component in the preparation of the resin (A).

The present invention is the aqueous resin dispersion wherein a cross-linkable monomer is used as an additional copolymerization component in the synthesis of the resin (B).

The present invention is the aqueous resin dispersion having a low shear region (0.1 sec⁻¹) viscosity of not less than 5,000 Pa.S and having a high shear region (100 sec⁻¹) viscosity of not more than 20 Pa.S after thickening with alkali.

The present invention is the aqueous resin dispersion wherein the change rate of the viscosity after being allowed to stand for 1 week is within 10% from the initial viscosity after thickening with alkali.

In addition, the present invention is a method for producing an aqueous resin dispersion comprising the steps of:

(1) preparing an aqueous solution resin (A) for emulsion polymerization having an acid value of 30 to 150 and a hydroxyl group value of 10 to 100 by aqueous-solution-polymerizing an acid group-containing polymerizable unsaturated monomer (a), a hydroxyl group-containing polymerizable unsaturated monomer (b), and any other polymerizable unsaturated monomer (c) in water; and

(2) synthesizing a resin (B) having an acid value of not more than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a), thereby obtaining the aqueous resin dispersion.

By this production method, an aqueous resin dispersion with an initial viscosity of not less than 3,000 mPa.S after thickening with alkali and a structural viscosity index of not less than 250, which is represented as a ratio between a low shear region (0.1 sec⁻¹) viscosity and a high shear region (100 sec⁻¹) viscosity:

(structural viscosity index)=(low shear region viscosity)/(high shear region viscosity)

is obtained.

The present invention is the method for producing an aqueous resin dispersion, wherein the any other polymerizable unsaturated monomer (c) includes at least one monomer selected from the group consisting of (meth)acrylates, styrenic monomers, (meth)acrylonitrile, and (meth).acrylamide.

The present invention is the method for producing an aqueous resin dispersion, wherein each of the monomer components are used so that the total weight Aw of the polymerizable unsaturated monomers in the preparation of the resin (A) and the total weight Bw of the polymerizable unsaturated monomers in the synthesis of the resin (B) satisfy the relationship represented by the following equation:

10/100≦Aw/(Aw+Bw)≦50/100.

The present invention is the method for producing an aqueous resin dispersion, wherein a cross-linkable monomer is used as an additional copolymerization component in the preparation of the resin (A).

The present invention is the method for producing an aqueous resin dispersion, wherein a cross-linkable monomer is used as an additional copolymerization component in synthesizing the resin (B).

### MODES FOR CARRYING OUT THE INVENTION

The present invention relates to an aqueous resin dispersion liquid (C) comprising an emulsion which the resin (B) is stabilized by the aqueous solution resin (A) acting as a protective colloid, and a method for producing the same.

Hereinafter, the present invention will be described in detail. It is noted-that, in the description, an “acrylic” polymerizable unsaturated monomer and a “methacrylic” polymerizable unsaturated monomer are combined to be referred to as a “(meth)acrylic” monomer.

An acid group-containing polymerizable unsaturated monomer (a) is a compound having not less than one unsaturated double bonds and acid groups in one molecule, respectively, and the acid group may, for example, be selected from carboxyl group, sulfonate group and phosphate group and the like.

Among the acid group-containing polymerizable unsaturated monomers (a), examples of the carboxyl group-containing monomer may include acrylic acid, methacrylic acid, crotonic acid, ethacrylic acid, propylacrylic acid, isopropylacrylic acid, itaconic acid, maleic anhydride, fumaric acid and the like. Examples of the sulfonate group-containing monomer may include t-butylacrylamidesulfonic acid and the like, while examples of the phosphate group-containing monomer may include Light Ester PM (manufactured by KYOEISHA CHEMICAL, Co., Ltd.) and the like. One kind or two or more kinds of these may be suitably used alone or in combination thereof.

Examples of the hydroxyl group-containing polymerizable unsaturated monomer (b) may include 2-hydroxyethyl acrylate, 2-hydroxyethyl methacrylate, hydroxypropyl acrylate, hydroxypropyl methacrylate, hydroxybutyl acrylate, hydroxybutyl methacrylate, N-methylol acrylamide, allyl alcohol, ε-caprolactone-modified acrylic monomer and the like. One kind or two or more kinds of these may be suitably used alone or in combination thereof.

Examples of the ε-caprolactone-modified acrylic monomer may include “PLACCEL FA-1”, “PLACCEL FA-2”, “PLACCEL FA-3”, “PLACCEL FA-4”, “PLACCEL FA-5”, “PLACCEL FM-1”, “PLACCEL FM-2”, “PLACCEL FM-3”, “PLACCEL FM-4”, “PLACCEL FM-5” manufactured by Daicel Chemical Industries, Ltd. and the like.

For any other polymerizable unsaturated monomer (c), a (meth)acrylate may be mainly used and a styrenic monomer is suitably used.

For (meth)acrylate monomer, a monoester of a monohydric alcohol having 1 to 24 carbon atoms with acrylic acid or methacrylic acid may be preferably used and examples thereof include methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, n-octyl (meth)acrylate, lauryl (meth)acrylate, stearyl (meth)acrylate and the like. One kind or two or more kinds of these may be suitably used alone or in combination thereof.

For styrenic monomer, in addition to styrene, α-methylstyrene and the like may be used. For other monomers, for example, monomers such as (meth)acrylonitrile and (meth)acrylamide may also be used in suitable amounts appropriately.

An aqueous solution resin for emulsion polymerization (A) has an acid value of 30 to 150 mgKOH/g, preferably 40 to 130 mgKOH/g, and a hydroxyl group value of 10 to 100 mgKOH/g, preferably 30 to 80 mgKOH/g.

An acid value of the resin (A) smaller than 30 causes insufficient thickening upon addition of an alkali to the aqueous resin dispersion obtained finally, resulting in a difficulty in obtaining expected viscosity and structural viscosity. On the other hand, an acid value exceeding 150 causes undesirable reduction in the water resistance of the coating film. A hydroxyl group value of the resin (A) smaller than 10 causes insufficient curing reaction with a melamine resin added as a curing agent in various usages of the finally obtained aqueous resin dispersion, resulting in deterioration of various strength characteristics of the coating film, especially in the scratch resistance and the acid resistance. On the other hand, a hydroxyl group value exceeding 100 causes reduced compatibility with the melamine resin, resulting in an increased strain of the coating film, which leads to undesirable reduction in the water resistance.

The resin (A) may be prepared by any of the following two methods.

A first method for preparing the resin (A) will be described.

For preparing the resin (A), an acid group-containing polymerizable unsaturated monomer (a), a hydroxyl group-containing polymerizable unsaturated monomer (b), and any other polymerizable unsaturated monomer (c) are used in such a ratio that both of the acid value and the hydroxyl group value of the resin (A) to be obtained are within the above described range. The monomer components of the acid group-containing monomer (a), hydroxyl group-containing monomer (b) and any other monomer (c) are copolymerized by an organic solvent solution polymerization method employed in the synthesis of ordinary acrylic resin or vinylic resin, etc. The copolymerization may be carried out, for example, by dissolving the above described monomer components in an organic solvent and stirring with heating in the presence of a radical polymerization initiator at a temperature of about 60 to 180° C. It is preferable that the reaction time is about 1 to 10 hours.

Examples of the above described organic solvent may include an ester-type solvent such as ethyl acetate, n-butyl acetate, isobutyl acetate, methylcellosolve acetate and butylcarbitol acetate, a lower alcohol-type solvent such as methanol, ethanol, isopropanol, n-butanol, sec-butanol and isobutanol, an ether-type solvent such as n-butyl ether, dioxane, ethylene glycol monomethyl ether, ethylene glycol monoethyl ether, propylene glycol monomethyl ether and propylene glycol monoethyl ether.

For radical polymerization initiator, a known initiator usually used in solution polymerization of an acrylic resin may be used. Specifically, a peroxide-type compound such as t-butyl hydroperoxide, t-butyl peroxy-2-ethoxyhexanoate, and an azo-type compound such as azobisisobutyronitrile, azobis(2-methylbutyronitrile) and azobisdimethyl-valeronitrile are used.

The organic solvent solution of a copolymeric resin thus obtained is converted into an aqueous solution by a standard method. Specifically, acidic groups contained in the copolymeric resin are neutralized with a basic compound and then water is added to dissolve the resin in water.

The preferred examples of the basic compound used in the neutralization include monomethylamine, dimethylamine, trimethylamine, monoethylamine, triethylamine, monoisopropylamine, diethylene triamine, triethylene triamine, triethylene tetramine, monoethanolamine, diethanolamine, triethanolamine, monoisopropanolamine, diisopropanolamine, dimethylethanolamine, 2-aminomethylpropanol, morpholin, methylmorpholin, piperazine, ammonia, sodium hydroxide, potassium hydroxide, lithium hydroxide and the like.

The aqueous solution of the copolymeric resin thus obtained contains an organic solvent. In the present invention, the organic solvent is removed by an ordinary distillation under reduced pressure. This distillation under reduced pressure may be performed, for example, under a reduced pressure of 5 to 30 kPa at a temperature of 40 to 80° C. for 1 to 10 hours. It is preferable to remove the organic solvent almost completely.

As described above, the aqueous solution resin for emulsion polymerization (A) is prepared. The weight average molecular weight of the resultant resin (A) is not limited particularly but usually about 10,000 to 50,000, for example, about 20,000 to 30,000.

Then, a second method for preparing the resin (A) will be described.

For preparing the resin (A), an acid group-containing polymerizable unsaturated monomer (a), a hydroxyl group-containing polymerizable unsaturated monomer (b), and any other polymerizable unsaturated monomer (c) are used in such a ratio that both of the acid value and the hydroxyl group value of the resin (A) to be obtained is within the above described range. The monomer components of the acid group-containing monomer (a), the hydroxyl group-containing monomer (b) and any other monomer (c) are copolymerized by an aqueous solution polymerization method employed in the synthesis of ordinary acrylic resin or vinylic resin. The copolymerization may be carried out, for example, by heating the above described monomer components with stirring in the presence of a radical polymerization initiator at a temperature of about 60 to 100° C. The reaction time is preferably about 1 to 10 hours, the reaction temperature is adjusted by adding the monomer mixture solution at once or dropwise to a reaction vessel containing water. Upon synthesizing the aqueous solution resin (A), it is often preferable to use as appropriate a slight amount of surfactant and auxiliary agents such as a hydrophilic oligomer or polymer as well as a mercaptan-type substance for adjusting the molecular weight in proceeding the aqueous solution polymerization.

For radical polymerization initiator, a known initiator usually used in aqueous solution polymerization of an acrylic resin may be used. Specifically, a peroxide-type compound such as t-butyl hydroperoxide, t-butyl peroxy-2-ethoxyhexanoate, and an azo-type compound such as azobisisobutyronitrile and azobisdimethyl valeronitrile are used, and for water-soluble free radical polymerization initiator, a persulfate such as potassium persulfate, sodium persulfate and ammonium persulfate may be used alone or in combination with hydrogen peroxide and a reducing agent such as acidic sodium sulfite, sodium thiosulfate, Rongalit and ascorbic acid, which is referred to as a redox initiator, each being used in the form of an aqueous solution.

The aqueous solution copolymeric resin (A) thus obtained may be used as it is in the emulsion polymerization of the resin (B) as a protective colloid, and a part of the acid groups in the resin (A) may be neutralized prior to use. The preferred examples of the basic compound used in the neutralization include monomethylamine, dimethylamine, trimethylamine, monoethylamine, triethylamine, monoisopropylamine, diethylene triamine, triethylene triamine, triethylene tetramine, monoethanolamine, diethanolamine, triethanolamine, monoisopropanolamine, diisopropanolamine, dimethylethanolamine, 2-aminomethylpropanol, morpholin, methylmorpholin, piperazine, ammonia, sodium hydroxide, potassium hydroxide, lithium hydroxide and the like.

As described above, the aqueous solution resin for emulsion polymerization (A) is prepared. The weight average molecular weight of the resultant resin (A) is not limited particularly but usually about 10,000 to 50,000, for example about 20,000 to 30,000.

Then, the aqueous solution resin for emulsion polymerization (A) prepared by any of the above described methods is used as a protective colloid and the any other polymerizable unsaturated monomer (c), and optionally the hydroxyl group-containing polymerizable unsaturated monomer (b), and optionally the acid group-containing polymerizable unsaturated monomer (a) are emulsion-polymerized, thereby synthesizing a resin (B) having an acid value of not more than 20 mgKOH/g and a hydroxyl group value of not more than 100 mgKOH/g in the protective colloid, while obtaining an aqueous resin dispersion containing polymer particles having the resin (B) in the resin (A).

The emulsion polymerization of the resin (B) is performed by using the resin (A) as a protective colloid and by polymerizing a mixture of any other monomer (c), and optionally the hydroxyl group-containing monomer (b) and optionally the acid group-containing monomer (a) in accordance with an ordinary emulsion polymerization procedure. The above monomers (a), (b) and (c) used in the emulsion polymerization of the resin (B) may similarly be selected from the groups of monomers (a), (b) and (c) exemplified above.

In the emulsion polymerization of the resin (B), the acid group-containing monomer (a) and the hydroxyl group-containing monomer (b) are optional components.

Upon using the acid group-containing monomer (a), its amount should be determined so that the resultant resin (B) has an acid value of not more than 20 mgKOH/g, preferably not more than 10 mgKOH/g. The acid value of the resin (B) exceeding 20 mgKOH/g causes increased change with time in the viscosity of the aqueous resin dispersion obtained after being thickened by adding an alkali to the dispersion, resulting in undesirable poor stability.

Upon using the hydroxyl group-containing monomer (b), its amount should be determined so that the resultant resin (B) has a hydroxyl group value of not more than 100 mgKOH/g, preferably not more than 70 mgKOH/g. The hydroxyl group value of the resin (B) exceeding 100 mgKOH/g causes poor water resistance of the coating film and poor compatibility with a melamine resin, resulting in an increased strain and accompanying reduction of mechanical strength. On the other hand, a lower hydroxyl group content in the resin (B) allows the curing reaction with the melamine resin added as a curing agent in the use of an aqueous resin dispersion to occur only on the outer shell of an emulsion particle, resulting in an irregularly structured coating film, which may cause an adverse effect for example on the mechanical strength. From this point of view, the hydroxyl group value of the resin (B) is preferably not less than 20 mgKOH/g, and accordingly the hydroxyl group-containing monomer (b) is preferable used so that the hydroxyl group value is from not less than 20 mgKOH/g to not more than 70 mgKOH/g.

The emulsion polymerization of the resin (B) is performed by adding the monomer components of the acid group-containing monomer (a) (if necessary), the hydroxyl group-containing monomer (b) (if necessary), and any other monomer (c) to water at once or dropwise continuously in the presence of the aqueous solution resin (A) and a free radical polymerization initiator. The emulsion polymerization may be carried out, for example, by stirring the above described monomer components in the presence of the resin (A) and the free radical polymerization initiator with heating at a temperature of about 30 to 100° C. The reaction time is preferably about 1 to 10 hours. During this step, in addition to the resin (A), an emulsifier used in ordinary emulsion polymerization may be used as an aid for the emulsification. A chain transfer agent may also be used suitably.

For emulsifier, an anionic or non-ionic emulsifier may be used, which is selected from micelle compounds each having, in its molecule, a hydrocarbon group having not less than 6 carbon atoms and a hydrophilic part such as carboxylate, sulfonate or sulfate. Among such compounds, examples of the anionic emulsifier include an alkaline metal salt or ammonium salt of a halfester of sulfuric acid with alkylphenols or higher alcohols; an alkaline metal salt or ammonium salt of an alkyl- or allyl-sulfonate; an alkaline metal salt or ammonium salt of a halfester of sulfuric acid with a polyoxyethylene alkylphenyl ether, polyoxyethylene alkyl ether or polyoxyethylene allyl ether and the like. Examples of the non-ionic emulsifier may include polyoxyethylene alkyl phenyl ether, polyoxyethylene alkyl ether or polyoxyethylene allyl ether and the like. In addition to these ordinary and commonly used anionic and non-ionic emulsifier, any of various anionic or non-ionic reactive emulsifier having in its molecule a radically polymerizable unsaturated double bond, i.e., having an acryl-, methacryl-, propenyl-, allyl-, allyl ether-, maleate-type groups may be used alone or in combination with each other.

For the polymerization initiator, a persulfate which is decomposed in water to form a free radical, such as potassium persulfate, sodium persulfate and ammonium persulfate may be used alone or in combination with hydrogen peroxide and a reducing agent such as acidic sodium sulfite, sodium thiosulfate, Rongalit and ascorbic acid, which is referred to as a redox initiator, each being used in the form of an aqueous solution.

The weight average molecular weight of the resin (B) thus obtained is not limited particularly but usually 50,000 to 1,000,000, for example 100,000 to 1,000,000.

In the present invention, it is preferable that each monomer component is used so that the total weight Aw of the polymerizable unsaturated monomers in the preparation of the resin (A) and the total weight Bw of the polymerizable unsaturated monomers in the synthesis of the resin (B) satisfy the relationship represented by the following equation:

10/100≦Aw/(Aw+Bw)≦50/100.

The value of Aw smaller than the range specified above is undesirable because it tends to cause poor alkali thickening performance of the aqueous resin dispersion to be obtained finally. On the other hand, a value of. Aw exceeding the range specified above is unpreferable because it tends to cause reduction in the water resistance, although it gives a sufficient alkali thickening performance. It is more preferable that each monomer component is used so that the relationship represented by the following equation:

20/100≦Aw/(Aw+Bw)≦40/100

is satisfied.

In the present invention, in either or both of the preparations of the resin (A) and the resin (B), a cross-linkable monomer may also preferably be used as a copolymerization component in addition to the above described monomers (a), (b) and (c). The resin is imparted with a cross-linking structure by copolymerizing a cross-linkable monomer, or imparted with the cross-linking structure by the reaction with cross-linking auxiliary agent upon forming coating film depending on the type of the cross-linkable monomer, resulting in a highly solvent-resistance coating film.

An increased solvent resistance of the coating film is highly beneficial. For example, in a case where an aqueous resin dispersion of the present invention is utilized as a waterborne base coating material in the formation of multilayer coating film on an automobile and the like, a clear coating material is coated on the base coating film once formed, and the surface of this base coating film can avoid any impairment or denatured layer formation owing to the solvents contained in the clear coating material and thus can reduce the interlayer diffused reflection between the base coating film and clear coating film, resulting in a multilayer coating film with an excellent appearance. An aqueous resin dispersion of the present invention can also be utilized in various usages involving exposure to or contact with a solvent.

For the cross-linkable monomer, a cross-linkable monomer having a polymerizable unsaturated group such as a carbonyl group-containing monomer, hydrolyzable silyl group-containing monomer, glycidyl group-containing monomer and any of various polyfunctional vinyl monomers may be used. N-Methylol (meth)acrylamide and N-methoxymethyl (meth)acrylamide are also cross-linkable, but to a rather less extent.

An example of the carbonyl group-containing monomer may include a keto group-containing monomer such as acrolein, diacetone (meth)acrylamide, acetoacetoxyethyl (meth)acrylate, formylstyrol, a vinylalkyl ketone having 4 to 7 carbon atoms (for example, vinylmethyl ketone, vinylethyl ketone, vinylbutyl ketone) and the like. Among those listed above, diacetone (meth)acrylamide is preferred. When using such a carbonyl group-containing monomer, a hydrazine-type compound as a cross-linking auxiliary agent is added to an aqueous resin dispersion to form the cross-linking structure upon forming a coating film.

Examples of the hydrazine-type compound may include a saturated aliphatic carboxylic acid dihydrazide having 2 to 18 carbon atoms such as oxalic acid dihydrazide, malonic acid dihydrazide, glutaric acid dihydrazide, succinic acid dihydrazide, adipic acid dihydrazide and sebacic acid dihydrazide; a monoolefinic unsaturated dicarboxylic acid dihydrazide such as maleic acid dihydrazide, fumaric acid dihydrazide and itaconic acid dihydrazide; phthalic acid dihydrazide, terephthalic acid dihydrazide, isophthalic acid dihydrazide and dihydrazide, trihydrazide or tetrahydrazide of pyromellitic acid; nitrile trihydrazide, citric acid trihydrazide, 1,2,4-benzene trihydrazide, ethylenediamine tetraacetic acid tetrahydrazide, 1,4,5,8-naphthoic acid tetrahydrazide and a polyhydrazide obtained by reacting an oligomer having a lower alkyl carboxylate group with hydrazine or hydrazine hydrate; carboxyl dihydrazide and bissemicarbazide; an aqueous polyfunctional semicarbazide obtained by reacting a diisocyanate such as hexamethylene diisocyanate and isophorone diisocyanate or a polyisocyanate compound derived therefrom with an excess of a hydrazine compound or dihydrazide listed above and the like.

An example of the hydrolyzable silyl group-containing monomer may include an alkoxysilyl group-containing monomer such as γ-(meth)acryloxypropylmethyldimethoxysilane, γ-(meth)acryloxypropylmethyldiethoxysilane, γ-(meth)acryloxypropyltriethoxysilane and the like.

Examples of the glycidyl group-containing monomer may include glycidyl (meth)acrylate, β-methylglycidyl (meth)acrylate, (3,4-epoxycyclohexyl)methyl (meth)acrylate, 3-chloro-2-hydroxypropyl (meth)acrylate and the like.

Examples of the polyfunctional vinylic monomer may include a divinyl compound such as divinylbenzene, ethylene glycol di(meth)acrylate, propylene glycol di(meth)acrylate, hexanediol di(meth)acrylate, diethylene glycol di(meth)acrylate, polyethylene glycol di(meth)acrylate, polypropylene glycol di(meth)acrylate, allyl (meth)acrylate, neopentyl glycol di(meth)acrylate and pentaerythritol di(meth)acrylate, and also include pentaerythritol tri(meth)acrylate, trimethyrol propane tri(meth)acrylate, dipentaerythritol hexa(meth)acrylate and the like.

Any of the cross-linkable monomers listed above may be used alone or in combination with each other. Among the cross-linkable monomers listed above, carbonyl group-containing monomers and hydrolyzable silyl group-containing monomers are preferable at the point of the improving effect of the solvent resistance of a resultant coating film.

When using the cross-linkable monomer in the preparation processes of the resins (A) and (B), the cross-linkable monomer is used in a range of 0.5 to 10% by weight, preferably 1 to 8% by weight based on the total amount of the above described monomers (a), (b) and (c). With the amount of this range, it is possible to obtain a cross-linking structure of the resins (A) and (B) and also to obtain the improving effect of solvent resistance of the coating film, although the amount may vary depending on the type of the monomers. An amount less than the range specified above may cause a difficulty in obtaining the improving effect of solvent resistance of the coating film, while an amount exceeding the range specified above may cause problematic gelling during the manufacturing process of the resins or may cause problematically irregular coating film even if there is no problem in the manufacturing processes of the resins.

The introduction of the cross-linking structure may be performed in both of the resins (A) and (B) or in any one of them. In the case where the cross-linking structure is introduced into only one of the resins, when Aw≦Bw, a higher improving effect of solvent resistance of the coating film can be obtained by introducing the cross-linking structure into the resin (B) than into the resin (A). In the case where the cross-linking structure is introduced into both of the resins (A) and (B), when a carbonyl group-containing monomer is used as a cross-linkable monomer, the cross-linking structure is formed readily even between the resins (A) and (B) as a result of the effect of a hydrazine-type compound upon forming a coating film.

As described above, the resin (B) is synthesized in the resin (A) serving as a protective colloid, thereby obtaining the aqueous resin dispersion (C) of the present invention.

An aqueous resin dispersion of the present invention has an initial viscosity of not less than 3,000 mPa.S after thickening with alkali. The initial viscosity after thickening with alkali herein means a viscosity, measured by type-B viscometer, of an initial sample which has been allowed to stand for 24 hours at 20° C. after adding an alkali to an aqueous resin dispersion having a nonvolatile content adjusted to 20% by weight and adjusting pH to 8.2. The initial viscosity after thickening with alkali less than 3,000 mPa.S causes increased sagging of the resin solution along the vertical surface and deteriorated orientation of an aluminum pigment in automobile coating material, resulting in poor appearance. The initial viscosity after thickening with alkali is not more than 20,000 mPa.S. The initial viscosity exceeding 20,000 mPa.S causes reduction in the extension or fluidity of the resin solution, resulting in poor workability and difficulty in increasing the nonvolatile content of the coating material. The initial viscosity after thickening with alkali is preferably from not less than 5,000 mPa.S to not more than 20,000 mPa.S, more preferably from not less than 7,000 mPa.S to not more than 18,000 mPa.S.

It is practically preferable that, as the change with time in the viscosity after thickening with alkali, the increase in the viscosity after allowing to stand for 1 week is within 10% of the initial viscosity.

In the aqueous resin dispersion of the present invention, a structural viscosity index, which is represented as a ratio between a low shear region (0.1 sec⁻¹) viscosity and a high shear region (100 sec⁻¹) viscosity:

(structural viscosity index)=(low shear region viscosity)/(high shear region viscosity),

is not less than 250, preferably not less than 700, and more preferably not less than 1,000. The low shear region (0.1 sec⁻¹) viscosity and the high shear region (100 sec⁻¹) viscosity herein mean the viscosity values of the same initial sample as described above after being thickened with alkali, which are measured using a viscoelastivity meter at 0.1 sec⁻¹ and 100 sec⁻¹, respectively.

A structural viscosity index less than 250 causes increased sagging of the resin solution along the vertical surface and deteriorated orientation of an aluminum pigment in automobile coating material, resulting in poor appearance or finish. The upper limit of the structural viscosity index is not specified particularly, and a higher index is more preferable, provided that a low shear region (0.1 sec⁻¹) viscosity which will be described below is within the preferable range.

In the present invention, the low shear region (0.1 sec⁻¹) viscosity is preferably from not less than 5,000 Pa.S to not more than 20,000 Pa.S, more preferably from not less than 7,000 Pa.S to not more than 18,000 Pa.S. A low shear region viscosity less than 5,000 Pa.S causes deteriorated sagging resistance of the resin solution along the vertical surface and deteriorated orientation of an aluminum pigment in automobile coating material, resulting in poor appearance. On the other hand, a viscosity exceeding 20,000 Pa.S causes a reduction in the extension or fluidity of the resin solution, resulting in poor workability and difficulty in increasing the nonvolatile content of the coating material, thereby leading to a problematically prolonged drying time.

In the present invention, the high shear region (100 sec⁻¹) viscosity is preferably not more than 20 Pa.S, more preferably not more than 10 Pa.S. A high shear region viscosity exceeding 20 Pa.S causes a poor spraying performance upon coating, resulting in problematically poor workability. In this point of view, a lower high shear region viscosity is more preferable, but is accompanied with corresponding reduction in the low shear region viscosity, so the high shear region viscosity should be adjusted so that the low shear range viscosity is in the preferable range specified above. Provided that the low shear region viscosity is within the above described preferable range, a lower high shear region viscosity is more preferable. It is preferable that the ratio between the low shear region viscosity and the high shear region viscosity is not less than 700, more preferably not less than 1,000.

### EXAMPLES

Hereinafter, the present invention will be described in the following Examples, which is not limited thereto. In the following description, terms “parts” and “%” are based on weight unless otherwise indicated.

### Example 1

(Preparation of Aqueous Solution Resin for Emulsion Polymerization (A))

An ordinary reaction vessel for producing an acrylic, resin equipped with a stirrer, thermometer, dropping funnel, condenser~and nitrogen inlet was charged with 0.5 part of AMBN (2,2′-azobis(2-methylbutyronitrile) as a polymerization initiator and 100 parts of IPA (isopropylalcohol), and the temperature was raised to 80° C. with stirring. Subsequently, the monomer mixture which will be described below was added dropwise over a period of 5 hours with stirring. After completion of dropping, 0.3 part of AMBN dissolved in 15 parts of IPA was added to the reaction vessel, and then the reaction was continued at 80° C. for 2 hours.

| | |
|---|---|
| Methyl methacrylate | 55 Parts |
| n-Butyl acrylate | 40 Parts |
| 2-Hydroxyethyl methacrylate | 20 Parts |
| Methacrylic acid | 10 Parts |

After completion of the polymerization, 5 parts of 25% aqueous ammonia was added to the reaction vessel, to which 350 parts of water was added dropwise over a period of about 2 hours while stirring, thereby converting into an aqueous solution. After converting into the aqueous solution, IPA was evaporated off using a rotary evaporator to obtain the intended aqueous solution resin for emulsion polymerization (A). This aqueous solution resin for emulsion polymerization (A) had an acid value of 52 mgKOH/g and a hydroxyl group value of 69 mgKOH/g.

(Production of Aqueous Resin Dispersion)

An ordinary reaction vessel for producing an acrylic resin emulsion equipped with a stirrer, thermometer, dropping funnel, condenser and nitrogen inlet was charged with 225 parts of the aqueous solution resin for emulsion polymerization (A), 560 parts of water and 1 part of Newcol 707SF (Nippon Nyukazai Co., Ltd.), which were stirred and heated to 75° C., and then 5% by weight of. the monomer mixture which will be described below (acid value of resin (B): 3 mgKOH/g, hydroxyl group value: 41 mgKOH/g) and 0.5 part of ammonium persulfate dissolved in 5 parts of water were added and stirred for 20 minutes. Then the remaining 95% by weight of the monomer mixture was added dropwise at 80° C. over a period of 2 hours, and the mixture was kept at 80 to 85° C. further for 1 hour after completion of dropping, and then cooled.

| | |
|---|---|
| Methyl methacrylate | 90 Parts |
| n-Butyl acrylate | 100 Parts |
| 2-Hydroxyethyl methacrylate | 20 Parts |
| Methacrylic acid | 1 Part |

After cooling, a mixture of 1 part of dimethyl aminoethanol and 10 parts of water was added to obtain an aqueous resin dispersion (C) having a nonvolatile content of 30% by weight.

(Testing Method)

The resultant aqueous resin dispersion (C) was evaluated for its performance.

1. Alkali Thickening Performance and Change With Time in Viscosity

The aqueous resin dispersion (C) was diluted with water to the nonvolatile content of 20% by weight, and was added dropwise with a 10% by weight aqueous solution of dimethyl aminoethanol while stirring. The solution was adjusted pH to 8.2 and allowed to stand at 20° C. for 24 hours. This initial sample after alkali thickening was examined for the viscosity using a type-B viscometer. A roter No.4 was used at 23° C. at the rotation speed of 6 rpm.

In Example 1, the initial viscosity was 13,200 mPa.S. The viscosity of the sample after allowing to stand at 20° C. for 1 week was 13,400.mPa.S. Thus, there was almost no change with time in the viscosity after alkali thickening.

2. Structural Viscosity After Alkali Thickening

The same initial sample after alkali thickening as that in Section 1 described above was examined for the viscoelastivity at 25° C. using a viscoelasticity meter PHYSICA UDS200 (Nihon SiberHegner K. K.). The viscosity (Pa.S) at 0.1 sec⁻¹ was measured in a low shear region, while the viscosity (Pa.S) at 100 sec⁻¹ was measured in a high shear region.

In Example 1, the low shear region viscosity was 10,500 Pa.S and the high shear region viscosity was 8 Pa.S. The structural viscosity index was 1,310.

3. Warm Water Resistance Test of Coating Film

The aqueous resin dispersion (C) having a nonvolatile content adjusted to 20% by weight was applied onto an acrylic plate, dried at 105° C. for 3 minutes, and the acrylic plate was immersed in warm water at 60° C. for 7 days and then examined for any whitening of the coating film. The evaluation was made according to the following criteria.

◯: No whitening

Δ: Partially whitening

X: Entirely whitening

In Example 1, no whitening was observed in the coating film of the aqueous resin dispersion (C).

### Examples 2 to 6, Comparative Examples 1 to 6

In Examples 2 to 6 and Comparative Examples 1 to 6, an aqueous resin dispersions (C) was produced in the same manner as that in Example 1 except for changing the monomer composition of the aqueous solution resin for emulsion polymerization (A) and the emulsion polymerization monomer composition of the resin (B) as shown in Table 1 and Table 2, respectively. Each aqueous resin dispersion (C) thus obtained was evaluated for its performance in the same manner as the Testing method 1 to 3 in Example 1. The results are shown in Table 3. In Tables 1 and 2, an acid value and a hydroxyl group value were obtained by the calculation from the amount of each polymerizable unsaturated monomer contained in the monomer mixture, and represented as being rounded at the decimal point.

The abbreviations in Tables 1 and 2 are as shown below.

MMA: Methyl methacrylate

S: Styrene

BA: Butyl acrylate

EA: Ethyl acrylate

MAA: Methacrylic acid

AA: Acrylic acid

HEMA: 2-Hydroxyethyl methacrylate

HEA: 2-Hydroxyethyl acrylate

FA-3: PLACCEL FA-3 (Daicel Chemical Industries, Ltd.)

TABLE 1

| | Monomer composition of aqueous solution resin (A) | | | | | | | | Resin (A) | |
|---|---|---|---|---|---|---|---|---|---|---|
| | for emulsion polymerization (parts by weight) | | | | | | | | Acid | Hydroxyl |
| | MMA | S | BA | EA | MAA | AA | HEMA | HEA | value | group value |
| Example 1 | 55 | 0 | 40 | 0 | 10 | 0 | 20 | 0 | 52 | 69 |
| Example 2 | 45 | 12 | 40 | 0 | 0 | 8 | 20 | 0 | 50 | 69 |
| Example 3 | 30 | 12 | 0 | 58 | 10 | 0 | 0 | 15 | 52 | 58 |
| Example 4 | 30 | 0 | 0 | 75 | 10 | 0 | 0 | 10 | 52 | 39 |
| Example 5 | 55 | 0 | 34 | 0 | 0 | 16 | 20 | 0 | 100 | 69 |
| Example 6 | 60 | 0 | 40 | 0 | 10 | 0 | 0 | 15 | 52 | 58 |
| Comparative | 30 | 0 | 40 | 0 | 35 | 0 | 20 | 0 | 182 | 69 |
| Example 1 | | | | | | | | | | |
| Comparative | 30 | 0 | 0 | 75 | 10 | 0 | 0 | 10 | 52 | 39 |
| Example 2 | | | | | | | | | | |
| Comparative | 49 | 12 | 40 | 0 | 0 | 4 | 20 | 0 | 25 | 69 |
| Example 3 | | | | | | | | | | |
| Comparative | 20 | 12 | 0 | 53 | 10 | 0 | 0 | 30 | 52 | 116 |
| Example 4 | | | | | | | | | | |
| Comparative | 35 | 0 | 0 | 80 | 10 | 0 | 0 | 0 | 52 | 0 |
| Example 5 | | | | | | | | | | |
| Comparative | 30 | 12 | 0 | 58 | 10 | 0 | 0 | 15 | 52 | 58 |
| Example 6 | | | | | | | | | | |

TABLE 2

| | Monomer composition for polymerization of resin (B) | | | | | | | | | Resin (B) | |
|---|---|---|---|---|---|---|---|---|---|---|---|
| | (parts by weight) | | | | | | | | | Acid | Hydroxyl |
| | MMA | S | BA | EA | MAA | AA | HEMA | HEA | FA-3 | value | group value |
| Example 1 | 90 | 0 | 100 | 0 | 1 | 0 | 20 | 0 | 0 | 3 | 41 |
| Example 2 | 66 | 20 | 100 | 0 | 0 | 5 | 20 | 0 | 0 | 18 | 41 |
| Example 3 | 30 | 20 | 0 | 140 | 0 | 0 | 0 | 21 | 0 | 0 | 48 |
| Example 4 | 50 | 0 | 0 | 135 | 5 | 0 | 0 | 21 | 0 | 15 | 48 |
| Example 5 | 89 | 0 | 100 | 0 | 0 | 2 | 20 | 0 | 0 | 7 | 41 |
| Example 6 | 40 | 0 | 0 | 139 | 1 | 0 | 0 | 21 | 10 | 3 | 59 |
| Comparative | 90 | 0 | 100 | 0 | 1 | 0 | 20 | 0 | 0 | 3 | 41 |
| Example 1 | | | | | | | | | | | |
| Comparative | 45 | 0 | 0 | 135 | 10 | 0 | 0 | 21 | 0 | 31 | 48 |
| Example 2 | | | | | | | | | | | |
| Comparative | 66 | 20 | 100 | 0 | 0 | 5 | 20 | 0 | 0 | 18 | 41 |
| Example 3 | | | | | | | | | | | |
| Comparative | 30 | 20 | 0 | 140 | .0 | 0 | 0 | 21 | 0 | 0 | 48 |
| Example 4 | | | | | | | | | | | |
| Comparative | 50 | 0 | 0 | 135 | 5 | 0 | 0 | 21 | 0 | 16 | 48 |
| Example 5 | | | | | | | | | | | |
| Comparative | 20 | 20 | 120 | 0 | 0 | 0 | 0 | 51 | 0 | 0 | 117 |
| Example 6 | | | | | | | | | | | |

TABLE 3
Performance evaluation of aqueous resin dispersion

| | Alkali | | | | | |
|---|---|---|---|---|---|---|
| | thickening performance | | Structural viscosity of alkali-thickened resin | | | |
| | and change with time | | Low shear region | High shear region | Structural viscosity | Water |
| | Initial | Viscosity | (0.1 sec⁻¹) | (100 sec⁻¹) | index, | resistance |
| | viscosity | after 1 week | viscosity | viscosity | Low shear/High shear | of coating |
| | (mPa · s) | (mPa · s) | (Pa · s) | (Pa · s) | viscosity ratio | film |
| Example 1 | 13,200 | 13,400 | 10,500 | 8 | 1,310 | ◯ |
| Example 2 | 9,820 | 9,980 | 9,200 | 6.8 | 1,350 | ◯ |
| Example 3 | 12,600 | 12,800 | 10,300 | 7.8 | 1,320 | ◯ |
| Example 4 | 14,300 | 15,800 | 14,500 | 9.8 | 1,480 | ◯ |
| Example 5 | 17,600 | 17,900 | 18,700 | 13 | 1,440 | ◯ |
| Example 6 | 13,400 | 13,800 | 10,800 | 8.4 | 1,290 | ◯ |
| Comparative | 112,000 | 112,800 | 72,600 | 35 | 2,070 | X |
| Example 1 | | | | | | |
| Comparative | 17,600 | 48,600 | 15,400 | 26 | 590 | Δ |
| Example 2 | | | | | | |
| Comparative | 1,230 | 1,860 | 270 | 1.2 | 230 | ◯ |
| Example 3 | | | | | | |
| Comparative | 13,200 | 13,300 | 11,300 | 9.2 | 1,230 | Δ |
| Example 4 | | | | | | |
| Comparative | 14,200 | 17,400 | 11,800 | 9 | 1,310 | ◯ |
| Example 5 | | | | | | |
| Comparative | 13,600 | 13,600 | 10,600 | 13 | 820 | Δ |
| Example 6 | | | | | | |

As can be seen from Tables 1 to 3, each aqueous resin dispersion (C) in Examples 1 to 6 acquired a high viscosity by alkali thickening, exhibited an excellent stability with almost no change with time in the viscosity after thickening as well as a high structural viscosity after alkali thickening, and have a high water resistance of the coating film. As described above, each aqueous resin dispersion (C) in Examples 1 to 6 had an excellent performance even with a relatively low acid value.

On the contrary, Comparative Example 1 exhibited an excessively high alkali thickening performance, had a poor workability and exhibited a considerably poor water resistance of the coating film. In Comparative Example 2, the resin. (B) had an excessively high acid value, underwent a marked change with time after alkali thickening, and exhibited a poor stability. In Comparative Example 3, no high viscosity was obtained even after alkali thickening. In Comparative Example 4, the hydroxyl group value of the resin (A) was excessively high, resulting in a poor water resistance of the coating film. In Comparative Example 5, the change with time after alkali thickening was substantial. In Comparative Example 6, the hydroxyl group value of the resin (B) was excessively high, resulting in a poor water resistance of the coating film.

### Example 7

(Preparation of Aqueous Solution Resin for Emulsion Polymerization (A))

An ordinary reaction vessel for producing an acrylic resin equipped with a stirrer, thermometer, dropping funnel, condenser and nitrogen inlet was charged with 0.5 part of AMBN (2,2′-azobis(2-methylbutyronitrile) as a polymerization initiator and 100 parts of IPA (isopropylalcohol), and the temperature was raised to 80° C. with stirring. Subsequently, the monomer mixture which will be described below was added dropwise over a period of 5 hours with stirring. After completion of dropping, 0.3 part of AMBN dissolved in 15 parts of IPA was added to the reaction vessel, and then the reaction was continued at 80° C. for 2 hours.

| | |
|---|---|
| Methyl methacrylate | 55 Parts |
| n-Butyl acrylate | 40 Parts |
| 2-Hydroxyethyl methacrylate | 20 Parts |
| Methacrylic acid | 10 Parts |

After completion of the polymerization, 5 parts of 25% aqueous ammonia was added to the reaction vessel, to which 350 parts of water was added dropwise over a period of about 2 hours with stirring, thereby converting into an aqueous solution. After converting into the aqueous solution, IPA was evaporated off using a rotary evaporator to obtain the intended aqueous solution resin for emulsion polymerization (A). This aqueous solution resin for emulsion polymerization (A) had an acid value of 52 mgKOH/g and a hydroxyl group value of 69 mgKOH/g.

(Production of Aqueous Resin Dispersion)

An ordinary reaction vessel for producing an acrylic resin emulsion equipped with a stirrer, thermometer, dropping funnel, condenser and nitrogen inlet was charged with 225 parts of the aqueous solution resin for emulsion polymerization (A), 560 parts of water and 1 part of Newcol 707SF (Nippon Nyukazai Co., Ltd.),.which were stirred and heated to 75° C., and then 5% by weight of the monomer -mixture which will be described below (acid value of resin (B): 3 mgKOH/g, hydroxyl group value: 41 mgKOH/g) and 0.5 part of ammonium persulfate dissolved in 5 parts of water were added and stirred for 20 minutes. Then the remaining 95% by weight-of the monomer mixture was added dropwise at 80° C. over a period of 2 hours, and the mixture was kept at 80 to 85° C. further for 1 hour after completion of dropping, and then cooled.

| | |
|---|---|
| Methyl methacrylate | 87 Parts |
| n-Butyl acrylate | 97 Parts |
| Diacetone acrylamide | 6 Parts |
| 2-Hydroxyethyl methacrylate | 20 Parts |
| Methacrylic acid | 1 Part |

After cooling, a mixture of 1 part of dimethyl aminoethanol and 10 parts of water was added, and then 3 parts of adipic acid dihydrazide was added to obtain an aqueous resin dispersion (C) having a nonvolatile content of 30% by weight.

### Example 8

An aqueous resin dispersion (C) was produced in the same manner as that in Example 7 except for changing the emulsion polymerization monomer composition of the resin (B) as shown in Table 4 and using 5 parts of adipic acid dihydrazide.

### Examples 9 to 13

Each aqueous resin dispersion (C) was produced in the same manner as that in Example 7 except for changing the emulsion polymerization monomer composition of the resin (B) as shown in Table 4 and using no adipic acid dihydrazide.

Each aqueous resin dispersion (C) obtained in Examples 7 to 13 was evaluated for its performance in the same manner as the Testing method 1 to 3 in Example 1 and then further evaluated the solvent resistance of the resin coating film as described below.

4. Solvent Resistance Test of Coating Film

An aqueous resin dispersion (C) having a nonvolatile content adjusted to 20% by weight was applied onto an acrylic plate, dried at 105° C. for 3 minutes, and then a drop of MEK (methyl ethyl ketone) was dropped on this acrylic plate. The resin coating film was rubbed with a finger and the number of time of the rubbing action until the coating film was peeled off was counted. This number of time of rubbing was regarded as an index of the solvent resistance. The number of time of rubbing of not less than 5, preferably not less than 10 was regarded to indicate a practically very excellent solvent resistance. The aqueous resin dispersion (C) of Example 1 underwent the peel off of the coating film after only one rubbing action.

The results of the performance evaluation are shown in Table 5. In Table 4, an acid value and a hydroxyl group value were obtained by the calculation from the amount of each polymerizable unsaturated monomer contained in the monomer mixture, and represented as being rounded at the decimal point. The abbreviations in Table 4 are as shown below. Other abbreviations are the same as that in Tables 1 and 2.

DAAm: Diacetone acrylamide

KBM-502: Alkoxysilyl group-containing monomer manufactured by Shin-Etsu Chemical Co., Ltd.

KBM-503:. Alkoxysilyl group-containing monomer manufactured by Shin-Etsu Chemical Co., Ltd.

N-MAM: N-Methylol acrylamide

GMA: Glycidyl methacrylate

TABLE 4

| | | | | | | | | | | | | | | | Resin (B) | |
|---|---|---|---|---|---|---|---|---|---|---|---|---|---|---|---|---|
| | Monomer composition of resin (B) for polymerization (parts by weight) | | | | | | | | | | | | | | | Hydroxyl |
| | | | | | | | | | | | KBM- | KBM- | | | Acid | group |
| | MMA | S | BA | EA | MAA | AA | HEMA | HEA | FA-3 | DAAAm | 502 | 503 | N-MAM | GMA | value | value |
| Example 7* | 87 | 0 | 97 | 0 | 1 | 0 | 20 | 0 | 0 | 6 | 0 | 0 | 0 | 0 | 3 | 41 |
| Example 8* | 61 | 20 | 95 | 0 | 0 | 5 | 20 | 0 | 0 | 10 | 0 | 0 | 0 | 0 | 18 | 41 |
| Example 9 | 30 | 20 | 0 | 140 | 0 | 0 | 0 | 15 | 0 | 0 | 6 | 0 | 0 | 0 | 0 | 34 |
| Example 10 | 86 | 0 | 100 | 0 | 0 | 4 | 0 | 15 | 0 | 0 | 0 | 6 | 0 | 0 | 14 | 34 |
| Example 11 | 40 | 0 | 0 | 140 | 1 | 0 | 0 | 17 | 10 | 0 | 0 | 3 | 0 | 0 | 3 | 39 |
| Example 12 | 87 | 0 | 97 | 0 | 1 | 0 | 20 | 0 | 0 | 0 | 0 | 0 | 6 | 0 | 3 | 41 |
| Example 13 | 61 | 20 | 95 | 0 | 0 | 5 | 20 | 0 | 0 | 0 | 0 | 0 | 0 | 10 | 18 | 41 |

*In Examples 7 and 8, 3 parts and 5 parts, respectively, of adipic acid dihydrazide were added after the polymerization of the resin (B).

TABLE 5
Performance evaluation of aqueous resin dispersion

| | Alkali | | | | | | Solvent |
|---|---|---|---|---|---|---|---|
| | thickening performance | | Structural viscosity of alkali-thickened resin | | | | resistance |
| | and change with time | | Low shear region | High shear region | Structural viscosity | Water | of coating |
| | Initial | Viscosity after | (0.1 sec⁻¹) | (100 sec⁻¹) | index, | resistance | film, |
| | viscosity | 1 week | viscosity | viscosity | Low shear/High shear | of coating | MEK rubbing |
| | (mPa · s) | (mPa · s) | (Pa · s) | (Pa · s) | viscosity ratio | film | number |
| Example 7 | 13,800 | 14,000 | 10,800 | 8.4 | 1,286 | ◯ | 60 |
| Example 8 | 14,300 | 14,400 | 11,200 | 9.3 | 1,204 | ◯ | 85 |
| Example 9 | 10,800 | 10,800 | 9,820 | 5.8 | 1,693 | ◯ | 55 |
| Example 10 | 11,300 | 11,500 | 10,020 | 6.3 | 1,590 | ◯ | 55 |
| Example 11 | 12,800 | 12,900 | 10,800 | 6.8 | 1,588 | ◯ | 40 |
| Example 12 | 13,200 | 13,400 | 12,200 | 9.2 | 1,326 | ◯ | 5 |
| Example 13 | 13,800 | 14,200 | 11,500 | 9.8 | 1,173 | ◯ | 8 |

As can be seen from Tables 4 and 5, each aqueous resin dispersion (C) in Examples 7 to 13 acquired a high viscosity by alkali thickening, exhibited an excellent stability with almost no change with time in the viscosity after thickening as well as a high structural viscosity after alkali thickening, and have a high water resistance and solvent resistance of the coating film. Considerably high solvent resistance was exhibited especially by each of the aqueous resin dispersions (C) in Examples 7 to 11 which used diacetone acrylamide or a hydrolyzable silyl group-containing monomer as a cross-linkable monomer.

### Example 14

(Preparation of Aqueous Solution Resin for Emulsion Polymerization (A))

An ordinary reaction vessel for producing an acrylic resin equipped with a stirrer, thermometer, dropping funnel, condenser and nitrogen inlet was charged with 350 parts of water and temperature was raised to 75° C. 0.5 part of APS (ammonium persulfate) was charged and the monomer mixture which will be described below was added dropwise over a period of 5 hours with stirring. In parallel with dropping, 0.3 part of APS dissolved in 5 parts of water was added dropwise to the reaction vessel. After completion of dropping, the reaction was continued at 80° C. for 2 hours.

| | |
|---|---|
| Methyl methacrylate | 35 Parts |
| Ethyl acrylate | 65 Parts |
| 2-Hydroxyethyl acrylate | 15 Parts |
| Acrylic acid | 10 Parts |

After completion of the polymerization, the reaction vessel was cooled to obtain the intended aqueous solution resin for emulsion polymerization (A). This aqueous solution resin for emulsion polymerization (A) had an acid value of 63 mgKOH/g and a hydroxyl group value of 58 mgKOH/g.

(Production of Aqueous Resin Dispersion)

An ordinary reaction vessel for producing an acrylic resin emulsion equipped with a stirrer, thermometer, dropping funnel, condenser and nitrogen inlet was charged with 360 parts of the aqueous solution resin for emulsion polymerization (A), 400 parts of water and 1 part of Newcol 293 (Nippon Nyukazai Co., Ltd.), which were stirred and heated to 75° C., and then 5% by weight of the monomer mixture which will be-described below (acid value of resin (B): 3.7 mgKOH/g, hydroxyl group value: 34 mgKOH/g) and 0.5 part of ammonium persulfate dissolved in 5 parts of water were added and stirred for 20 minutes. Then the remaining 95% by weight of the monomer mixture was added dropwise at 80° C. over a period of 2 hours, and the mixture was kept at 80 to 85° C. further for 1 hour after completion of dropping, and then cooled.

| | |
|---|---|
| Methyl methacrylate | 115 Parts |
| n-Butyl acrylate | 80 Parts |
| 2-Hydroxyethyl acrylate | 15 Parts |
| Acrylic acid | 1 Part |

After cooling, a mixture of 3 part of dimethyl aminoethanol and 30 parts of water was added to obtain an aqueous resin dispersion (C) having a nonvolatile content of 30% by weight.

(Testing Method)

The resultant aqueous resin dispersion (C) was evaluated for its performance.

1. Alkali Thickening Performance and Change With Time in Viscosity

The aqueous resin dispersion (C) was diluted with water to the nonvolatile content of 20% by weight, and was added dropwise with a 10% by weight aqueous solution of dimethyl aminoethanol while stirring. The solution was adjusted pH to 8.2 and allowed to stand at 20° C. for 24 hours. This initial sample after alkali thickening was examined for the viscosity using a type-B viscometer. A roter No.4 was used at 23° C. at the rotation speed of 6 rpm. In Example 14, the initial viscosity was 8,280 mPa.S. The viscosity of the sample after allowing to stand at 20° C. for 1 week was 8,340 mPa.S. Thus, there was almost no change with time in the viscosity after alkali thicking.

2. Structural Viscosity After Alkali Thickening

The same initial sample after alkali thickening as that in Section 1 described above was examined for the viscoelastivity at 25° C. using a viscoelasticity meter PHYSICA UDS200 (Nihon SiberHegner K. K.). The viscosity (Pa.S) at 0.1 sec⁻¹ was measured in a low shear region, while the viscosity (Pa.S) at 100 sec⁻¹ was measured in a high shear region.

In Example 14, the low shear region viscosity was 7,240 Pa.S and the high shear region viscosity was 3.8 Pa.S. The structural viscosity index was 1,910.

3. Warm Water Resistance Test of Coating Film

The aqueous resin dispersion (C) having a nonvolatile content adjusted to 20% by weight was applied onto an acrylic plate, dried at 105° C. for 3 minutes, and the acrylic plate was immersed in warm water at 60° C. for 7 days and then examined for any whitening of the coating film. The evaluation was made according to the following criteria.

◯: No whitening

Δ: Partially whitening

X: Entirely whitening

In Example 14, no whitening was observed in the coating film-of the aqueous resin dispersion (C).

### Examples 15 to 19, Comparative Examples 7 to 12

In Examples 15 to 19 and Comparative Examples 7 to 12, an aqueous resin-dispersions (C) was produced in the same manner as that in Example 14 except for changing the monomer composition of the aqueous solution resin for emulsion polymerization (A) and the emulsion polymerization monomer composition of the resin (B) as shown in Table 6 and Table 7, respectively. Each aqueous resin dispersion (C) thus obtained was evaluated for its performance in the same manner as the Testing method 1 to 3 in Example 14. The results are shown in Table 8. In Tables 6 and 7, an acid value and a hydroxyl group value were obtained by the calculation from the amount of each polymerizable unsaturated monomer contained in the monomer mixture, and represented as being rounded at the decimal point.

The abbreviations in Tables 6 and 7 are as shown below.

MMA: Methyl methacrylate

S: Styrene

BA: Butyl acrylate

EA: Ethyl acrylate

MAA: Methacrylic acid

AA: Acrylic acid

HEMA: 2-Hydroxyethyl methacrylate

HEA: 2-Hydroxyethyl acrylate

FA-2: PLACCEL FA-2 (Daicel Chemical Industries, Ltd.)

TABLE 6

| | Monomer composition of aqueous solution resin (A) | | | | | | | | Resin (A) | |
|---|---|---|---|---|---|---|---|---|---|---|
| | for emulsion polymerization (parts by weight) | | | | | | | | Acid | Hydroxyl |
| | MMA | S | BA | EA | MAA | AA | HEMA | HEA | value | group value |
| Example 14 | 35 | 0 | 0 | 65 | 0 | 10 | 0 | 15 | 63 | 58 |
| Example 15 | 55 | 0 | 40 | 0 | 0 | 10 | 20 | 0 | 63 | 69 |
| Example 16 | 32 | 10 | 0 | 58 | 10 | 0 | 0 | 15 | 52 | 58 |
| Example 17 | 30 | 0 | 0 | 75 | 10 | 0 | 0 | 10 | 52 | 39 |
| Example 18 | 55 | 0 | 30 | 0 | 0 | 20 | 20 | 0 | 125 | 69 |
| Example 19 | 60 | 0 | 40 | 0 | 10 | 0 | 0 | 15 | 52 | 58 |
| Comparative | 35 | 0 | 40 | 0 | 0 | 30 | 20 | 0 | 188 | 69 |
| Example 7 | | | | | | | | | | |
| Comparative | 30 | 0 | 0 | 75 | 10 | 0 | 0 | 10 | 52 | 39 |
| Example 8 | | | | | | | | | | |
| Comparative | 61 | 0 | 40 | 0 | 0 | 4 | 20 | 0 | 25 | 69 |
| Example 9 | | | | | | | | | | |
| Comparative | 20 | 10 | 0 | 55 | 10 | 0 | 0 | 30 | 52 | 116 |
| Example 10 | | | | | | | | | | |
| Comparative | 35 | 0 | 0 | 80 | 10 | 0 | 0 | 0 | 52 | 0 |
| Example 11 | | | | | | | | | | |
| Comparative | 30 | 10 | 0 | 60 | 10 | 0 | 0 | 15 | 52 | 58 |
| Example 12 | | | | | | | | | | |

TABLE 7

| | Monomer composition for polymerization of resin (B) | | | | | | | | | Resin (B) | |
|---|---|---|---|---|---|---|---|---|---|---|---|
| | (parts by weight) | | | | | | | | | Acid | Hydroxyl |
| | MMA | S | BA | EA | MAA | AA | HEMA | HEA | FA-3 | value | group value |
| Example 14 | 115 | 0 | 80 | 0 | 0 | 1 | 0 | 15 | 0 | 4 | 34 |
| Example 15 | 68 | 20 | 100 | 0 | 0 | 3 | 20 | 0 | 0 | 11 | 41 |
| Example 16 | 30 | 20 | 0 | 140 | 0 | 0 | 0 | 21 | 0 | 0 | 48 |
| Example 17 | 50 | 0 | 0 | 135 | 5 | 0 | 0 | 21 | 0 | 15 | 48 |
| Example 18 | 89 | 0 | 100 | 0 | 0 | 2 | 20 | 0 | 0 | 7 | 41 |
| Example 19 | 40 | 0 | 0 | 139 | 1 | 0 | 0 | 21 | 10 | 3 | 61 |
| Comparative | 90 | 0 | 100 | 0 | 1 | 0 | 20 | 0 | 0 | 3 | 41 |
| Example 7 | | | | | | | | | | | |
| Comparative | 45 | 0 | 0 | 135 | 10 | 0 | 0 | 21 | 0 | 31 | 48 |
| Example 8 | | | | | | | | | | | |
| Comparative | 66 | 20 | 100 | 0 | 0 | 5 | 20 | 0 | 0 | 18 | 41 |
| Example 9 | | | | | | | | | | | |
| Comparative | 30 | 20 | 0 | 140 | 0 | 0 | 0 | 21 | 0 | 0 | 48 |
| Example 10 | | | | | | | | | | | |
| Comparative | 50 | 0 | 0 | 135 | 5 | 0 | 0 | 21 | 0 | 16 | 48 |
| Example 11 | | | | | | | | | | | |
| Comparative | 20 | 20 | 120 | 0 | 0 | 0 | 0 | 51 | 0 | 0 | 117 |
| Example 12 | | | | | | | | | | | |

TABLE 8
Performance evaluation of aqueous resin dispersion

| | Alkali | | | | | |
|---|---|---|---|---|---|---|
| | thickening performance | | Structural viscosity of alkali-thickened resin | | | |
| | and change with time | | Low shear region | High shear region | Structural viscosity | Water |
| | Initial | Viscosity | (0.1 sec⁻¹) | (100 sec⁻¹) | index, | resistance |
| | viscosity | after 1 week | viscosity | viscosity | Low shear/High shear | of coating |
| | (mPa · s) | (mPa · s) | (Pa · s) | (Pa · s) | viscosity ratio | film |
| Example 14 | 8,280 | 8,340 | 7,240 | 3.8 | 1,910 | ◯ |
| Example 15 | 6,810 | 7,120 | 5,620 | 2.6 | 2,160 | ◯ |
| Example 16 | 7,820 | 7,980 | 6,480 | 3.2 | 2,030 | ◯ |
| Example 17 | 8,680 | 9,820 | 7,600 | 4.8 | 1,580 | ◯ |
| Example 18 | 15,600 | 15,900 | 16,600 | 12 | 1,380 | ◯ |
| Example 19 | 7,840 | 7,820 | 6,680 | 3.4 | 1,970 | ◯ |
| Comparative | 88,600 | 93,400 | 56,700 | 31 | 1,830 | X |
| Example 7 | | | | | | |
| Comparative | 18,200 | 56,800 | 21,200 | 28 | 760 | Δ |
| Example 8 | | | | | | |
| Comparative | 1,020 | 1,960 | 190 | 2 | 85 | ◯ |
| Example 9 | | | | | | |
| Comparative | 8,200 | 8,320 | 9,400 | 9.8 | 960 | Δ |
| Example 10 | | | | | | |
| Comparative | 12,800 | 22,400 | 9,700 | 9.2 | 110 | ◯ |
| Example 11 | | | | | | |
| Comparative | 13,200 | 13,800 | 9,320 | 11 | 830 | Δ |
| Example 12 | | | | | | |

As can be seen from Tables 6 to 8, each aqueous resin dispersion (C) in Examples 14 to 19 acquired a high viscosity by alkali thickening, exhibited an excellent stability with almost no change with time in the viscosity after thickening as well as a high structural viscosity after alkali thickening, and have a high water resistance of the coating film. As described above, each aqueous resin dispersion (C) in Examples 14 to 19 had an excellent performance even with a relatively low acid value.

On the contrary, Comparative Example 7 exhibited an excessively high alkali thickening performance, had a poor workability and exhibited a considerably poor water resistance of the coating film. In Comparative Example 8, the resin (B) had an excessively high acid value, underwent a marked change with time after alkali thickening, and exhibited a poor stability. In Comparative Example 9, no high viscosity was obtained even after alkali thickening. In Comparative Example 10, the hydroxyl group value of the resin (A) was excessively high, resulting in a poor water resistance of the coating film. In Comparative Example 11, the change with time after alkali thickening was substantial, resulting in a bad structural viscosity. In Comparative Example 12, the hydroxyl group value of the resin (B) was excessively high, resulting in a poor water resistance of the coating film.

### Example 20

(Preparation of Aqueous Solution Resin for Emulsion Polymerization (A))

An ordinary reaction vessel for producing an acrylic resin equipped with a stirrer, thermometer, dropping funnel, condenser and nitrogen inlet was charged with 350 parts of water and temperature was raised to 75° C. 0.5 part of APS (ammonium persulfate) was charged and the monomer mixture which will be described below was added dropwise over a period of 5 hours with stirring. In parallel with dropping, 0.3 part of APS dissolved in 5 parts of water was added dropwise to the reaction vessel. After completion of dropping, the reaction was continued at 80° C. for 2 hours.

| | |
|---|---|
| Methyl methacrylate | 35 Parts |
| Ethyl acrylate | 65 Parts |
| 2-Hydroxyethyl acrylate | 15 Parts |
| Acrylic acid | 10 Parts |

After completion of the polymerization, the reaction vessel was cooled to obtain the intended aqueous solution resin for emulsion polymerization (A). This aqueous solution resin for emulsion polymerization (A) had an acid value of 63 mgKOH/g and a hydroxyl group value of 58 mgKOH/g.

(Production of Aqueous Resin Dispersion)

An ordinary reaction vessel for producing an acrylic resin emulsion equipped with a stirrer, thermometer, dropping funnel, condenser and nitrogen inlet was charged with 360 parts of the aqueous solution resin for emulsion polymerization (A), 400 parts of water and 1 part of Newcol 293 (Nippon Nyukazai Co., Ltd.), which were stirred and heated to 75° C., and then 5% by weight of the.monomer mixture which will be described below (acid value of resin (B): 3.7 mgKOH/g, hydroxyl group value: 34 mgKOH/g) and 0.5 part of ammonium persulfate dissolved in 5 parts of water were added and stirred for 20 minutes. Then the remaining 95% by weight of the monomer mixture was added dropwise at 80° C. over a period of 2 hours, and the mixture was kept at 80 to 85° C. further for 1 hour after completion of dropping, and then cooled.

| | | |
|---|---|---|
| Methyl methacrylate | 112 | Parts |
| n-Butyl acrylate | 77 | Parts |
| Diacetone acrylamide | 6 | parts |
| 2-Hydroxyethyl acrylate | 15 | Parts |
| Acrylic acid | 1 | Part |

After cooling, a mixture of 3 part of dimethyl aminoethanol and 30 parts of water was added, and then 3 parts of adipic acid dihydrazide was added to obtain an aqueous resin dispersion (C) having a nonvolatile content of 30% by weight.

### Example 21

An aqueous resin dispersion (C) was produced in the same manner as that in Example 20 except for changing the emulsion polymerization monomer composition of the resin (B) as shown in Table 9 and using 5 parts of adipic acid dihydrazide.

### Example 22 to 26

Each aqueous resin dispersion (C) was produced in the same manner as that in Example 20 except for changing the emulsion polymerization monomer composition of the resin (B) as shown in Table 9, and using no adipic acid dihydrazide.

Each aqueous resin dispersion (C) obtained in Examples 20 to 26 was evaluated for its performance in the same manner as the Testing method 1 to 3 in Example 14 and then further evaluated the solvent resistance of the resin coating film as described below.

4. Solvent Resistance Test of Coating Film

An aqueous resin dispersion (C) having a nonvolatile content adjusted to 20% by weight was applied onto an acrylic plate, dried at 105° C. for 3 minutes, and then a drop of MEK (methyl ethyl ketone) was dropped on this acrylic plate. The resin coating film was rubbed with a finger and the number of time of the rubbing action until the coating film was peeled off was counted. This number of time of rubbing was regarded as an index of the solvent resistance. The number of time of rubbing of not less than 5, preferably not less than 10 was regarded to indicate a practically very excellent solvent resistance. The aqueous resin dispersion (C) of Example 14 underwent the peel off of the coating film after one rubbing action.

The results of the performance evaluation are shown in Table 10. In Table 9, an acid value and a hydroxyl group value were obtained by the calculation from the amount of each polymerizable unsaturated monomer contained in the monomer mixture, and represented as being rounded at the decimal point. The abbreviations in Table 9 are as shown below. Other abbreviations are the same as that in Tables 6 and 7.

DAAAm: Diacetone acrylamide

KBM-502: Alkoxysilyl group-containing monomer manufactured by Shin-Etsu Chemical Co., Ltd.

KBM-503: Alkoxysilyl group-containing monomer manufactured by Shin-Etsu Chemical Co., Ltd.

N-MAM: N-Methylol acrylamide

GMA: Glycidyl methacrylate

TABLE 9

| | | | | | | | | | | | | | | | Resin (B) | |
|---|---|---|---|---|---|---|---|---|---|---|---|---|---|---|---|---|
| | Monomer composition of resin (B) for polymerization (parts by weight) | | | | | | | | | | | | | | | Hydroxyl |
| | | | | | | | | | | | KBM- | KBM- | | | Acid | group |
| | MMA | S | BA | EA | MAA | AA | HEMA | HEA | FA-3 | DAAAm | 502 | 503 | N-MAM | GMA | value | value |
| Example 20* | 112 | 0 | 77 | 0 | 0 | 1 | 0 | 15 | 0 | 6 | 0 | 0 | 0 | 0 | 4 | 34 |
| Example 21* | 63 | 20 | 95 | 0 | 0 | 3 | 20 | 0 | 0 | 10 | 0 | 0 | 0 | 0 | 11 | 41 |
| Example 22 | 30 | 20 | 0 | 140 | 0 | 0 | 0 | 15 | 0 | 0 | 6 | 0 | 0 | 0 | 0 | 34 |
| Example 23 | 86 | 0 | 100 | 0 | 0 | 4 | 0 | 15 | 0 | 0 | 0 | 6 | 0 | 0 | 14 | 34 |
| Example 24 | 40 | 0 | 0 | 140 | 1 | 0 | 0 | 17 | 10 | 0 | 0 | 3 | 0 | 0 | 3 | 39 |
| Example 25 | 87 | 0 | 97 | 0 | 1 | 0 | 20 | 0 | 0 | 0 | 0 | 0 | 6 | 0 | 3 | 41 |
| Example 26 | 61 | 20 | 95 | 0 | 0 | 5 | 20 | 0 | 0 | 0 | 0 | 0 | 0 | 10 | 18 | 41 |

*In Examples 20 and 21, 3 parts and 5 parts, respectively, of adipic acid dihydrazide were added after the polymerization of the resin (B).

TABLE 10
Performance evaluation of aqueous resin dispersion

| | Alkali | | | | | | Solvent |
|---|---|---|---|---|---|---|---|
| | thickening performance | | Structural viscosity of alkali-thickened resin | | | | resistance |
| | and change with time | | Low shear region | High shear region | Structural viscosity | Water | of coating |
| | Initial | Viscosity after | (0.1 sec⁻¹) | (100 sec⁻¹) | index, | resistance | film, |
| | viscosity | 1 week | viscosity | viscosity | Low shear/High shear | of coating | MEK rubbing |
| | (mPa · s) | (mPa · s) | (Pa · s) | (Pa · s) | viscosity ratio | film | number |
| Example 20 | 8,670 | 8,720 | 7,480 | 6.8 | 1,100 | ◯ | 55 |
| Example 21 | 7,020 | 7,120 | 6,620 | 6.4 | 1,034 | ◯ | 76 |
| Example 22 | 8,360 | 8,380 | 7,280 | 5.2 | 1,400 | ◯ | 48 |
| Example 23 | 8,980 | 9,020 | 7,660 | 6.1 | 1,256 | ◯ | 46 |
| Example 24 | 9,200 | 9,360 | 7,820 | 5.8 | 1,348 | ◯ | 32 |
| Example 25 | 9,360 | 9,580 | 8,840 | 7.8 | 1,133 | ◯ | 4 |
| Example 26 | 8,620 | 8,820 | 8,060 | 6.8 | 1,185 | ◯ | 6 |

As can be seen from Tables 9 and 10, each aqueous resin-dispersion (C) in Examples 20 to 26 acquired a high viscosity by alkali thickening, exhibited an excellent stability with almost no change with time in the viscosity after thickening as well as a high structural viscosity after alkali thickening, and have a high water resistance and solvent resistance of the coating film. Considerably high solvent resistance was exhibited especially by each of the aqueous resin dispersions (C) in Examples 20 to 24 which used diacetone acrylamide or a hydrolyzable silyl group-containing monomer as a cross-linkable monomer.

Industrial Applicability

According to the present invention, an aqueous resin dispersion is produced by use of an aqueous solution resin for emulsion polymerization (A) having a relatively low acid value and an appropriate hydroxyl group value obtained by the conversion into an aqueous solution after solution polymerization or aqueous solution polymerization as a useful protective colloid in the emulsion polymerization of a resin (B), and therefore an excellent alkali thickening performance and high structural viscosity can be obtained when using the aqueous resin dispersion of the present invention in fiber implantation or automobile coating process. Accordingly, by using an aqueous resin dispersion of the present invention, the workability becomes excellent during use and processing, and the finished appearance becomes satisfactory with a high water resistance of the coating film. According to the present invention, the acid value of the resin (B) is adjusted to a low value, which enables an aqueous resin dispersion of the present invention to suppress the change with time in the viscosity after alkali thickening and to exhibit an excellent stability. The aqueous resin dispersion of the present invention also exhibits an excellent compatibility with melamine and a satisfactory curing reactivity with melamine due to an appropriate level of the hydroxyl group used in the resins (A) and (B), thereby imparting a coating film with excellent acid resistance and scratch resistance.

In addition, according to the present invention, by using a cross-linkable monomer as a copolymeric component in the preparation of the resin (A) and/or the preparation of the resin (B), the coating film can be imparted with an excellent solvent resistance.

The present invention provides an aqueous resin dispersion having a relatively low acid value and high viscosity and structural viscosity after alkali neutralization, and a method for producing the same.

1. An aqueous resin dispersion obtained by:
(1) preparing an aqueous solution resin (A) for emulsion polymerization having an acid value of 30 to 150 and a hydroxyl group value of 10 to 100 by solution-polymerizing an acid group-containing polymerizable unsaturated monomer (a), a hydroxyl group-containing polymerizable unsaturated monomer (b), and any other polymerizable unsaturated monomer (c) in organic solvent to produce an organic solvent solution of a copolymer, converting the organic solvent solution into an aqueous solution, and removing the organic solvent under reduced pressure; and
(2) synthesizing a resin (B) having an acid value of not more than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a),
wherein the aqueous resin dispersion has an initial viscosity of not less than 3,000 mPa.S after thickening with alkali, and a structural viscosity index of not less than 250 after thickening with alkali, which is represented as a ratio between a low shear region (0.1 sec⁻¹) viscosity and a high shear region (100 sec⁻¹) viscosity:
(structural viscosity index)=(low shear region viscosity)/(high shear region viscosity).

2. The aqueous resin dispersion according to claim 1, wherein said any other polymerizable unsaturated monomer (c) includes at least one monomer selected from the group consisting of (meth)acrylates, styrenic monomers, (meth)acrylonitrile, and (meth)acrylamide.

3. The aqueous resin dispersion according to claim 1, wherein the total weight Aw of the polymerizable unsaturated monomers used in the preparation of said resin (A) and the total weight Bw of the polymerizable unsaturated monomers used in the synthesis of said resin (B) satisfy the relationship represented by the following equation:
10/100≦Aw/(Aw+Bw)≦50/100.

4. The aqueous resin dispersion according to claim 1, wherein a cross-linkable monomer is used as an additional copolymerization component in the preparation of said resin (A).

5. The aqueous resin dispersion according to claim 1, wherein a cross-linkable monomer is used as an additional copolymerization component in the synthesis of said resin (B).

6. A method for producing an aqueous resin dispersion comprising the steps of:
(1) preparing an aqueous solution resin (A) for emulsion polymerization having an acid value of 30 to-150 and a hydroxyl group value of 10 to 100 by solution-polymerizing an acid group-containing polymerizable unsaturated monomer (a), a hydroxyl group-containing polymerizable unsaturated monomer (b), and any other polymerizable unsaturated monomer (c) in organic solvent to obtain an organic solvent solution of a copolymer, converting the organic solvent solution into an aqueous solution, and removing the organic solvent under reduced pressure; and
(2) synthesizing a resin (B) having an acid value of not more than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a), thereby obtaining the aqueous resin dispersion.

7. The method for producing an aqueous resin dispersion according to claim 6, wherein a cross-linkable monomer is used as an additional copolymerization component in the preparation of said resin (A).

8. The method for producing an aqueous resin dispersion according to claim 6, wherein a cross-linkable monomer is used as an additional copolymerization component in the synthesis of said resin (B).

9. An aqueous resin dispersion obtained by:
(1) preparing an aqueous solution resin (A) for emulsion polymerization having an acid value of 30 to 150 and a hydroxyl group value of 10 to 100 by aqueous-solution-polymerizing an acid group-containing polymerizable unsaturated monomer (a), a hydroxyl group-containing polymerizable unsaturated monomer (b), and any other polymerizable unsaturated monomer (c) in water; and
(2) synthesizing a resin (B) having an acid value of not more than 20 and a hydroxyl group value of not more than 100 in a protective colloid by using the aqueous solution resin (A) for emulsion polymerization prepared in step (1) as said-protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a),
wherein the aqueous resin dispersion has an initial viscosity of not less than 3,000 mPa.S after thickening with alkali, and a structural viscosity index of not less than 250 after thickening with alkali, which is represented as a ratio between a low shear region (0.1 sec⁻¹) viscosity and a high shear region (100 sec⁻¹) viscosity:
(structural viscosity index)=(low shear region viscosity)/(high shear region viscosity).

10. The aqueous resin dispersion according to claim 9, wherein said any other polymerizable unsaturated monomer (c) includes at least one monomer selected from the group consisting of (meth)acrylates, styrenic monomers, (meth)acrylonitrile, and (meth)acrylamide.

11. The aqueous resin dispersion according to claim 9, wherein the total weight Aw of the polymerizable unsaturated monomers used in the preparation of said resin (A) and the total weight Bw of the polymerizable unsaturated monomers used in the synthesis of said resin (B) satisfy the relationship represented by the following equation:
10/100≦Aw/(Aw+Bw)≦50/100.

12. The aqueous resin dispersion according to claim 9, wherein a cross-linkable monomer is used as an additional copolymerization component in the preparation of said resin (A).

13. The aqueous resin dispersion according to claim 9, wherein a cross-linkable monomer is used as an additional copolymerization component in the synthesis of said resin (B).

14. A method for producing an aqueous resin dispersion comprising the steps of:
(1) preparing an aqueous solution resin (A) for emulsion polymerization having an acid value of 30 to 150 and a hydroxyl group value of 10 to 100 by aqueous-solution-polymerizing an acid group-containing polymerizable unsaturated monomer (a), a hydroxyl group-containing polymerizable unsaturated monomer (b), and any other polymerizable unsaturated monomer (c) in water; and
(2) synthesizing a resin (B) having an acid value of not more than 20 and a hydroxyl group value of not more than 100 in a protective colloid by using the aqueous solution resin (A) for emulsion polymerization prepared in step (1) as said protective colloid and by emulsion-polymerizing the any other polymerizable unsaturated monomer (c), and optionally the hydroxyl group-containing polymerizable unsaturated monomer (b), and optionally the acid group-containing polymerizable unsaturated monomer (a), thereby obtaining the aqueous resin dispersion.

15. A method for producing an aqueous resin dispersion according to claim 14, wherein a cross-linkable monomer is used as an additional copolymerization component in the preparation of said resin (A).

16. A method for producing an aqueous resin dispersion according to claim 14, wherein a cross-linkable monomer is used as an additional copolymerization component in the synthesis of said resin (B).
